(19) United States
(12) Patent Application Publication
(10) Pub. No.: US 2026/0003231 A1
(43) Pub. Date: Jan. 1, 2026

(54) OPTICAL SYSTEM AND DISPLAY DEVICE

(71) Applicant: SONY GROUP CORPORATION, Tokyo (JP)

(72) Inventor: Toshifumi YASUI, Kanagawa (JP)

(73) Assignee: SONY GROUP CORPORATION, Tokyo (JP)

(21) Appl. No.: 18/880,656

(22) PCT Filed: Jun. 9, 2023
(86) PCT No.: PCT/JP2023/021463

§ 371 Date: Jan. 2, 2025

(30) Foreign Application Priority Data
Jul. 15, 2022 (JP) 2022-113888

(51) Int. Cl. G02F 1/13363; G02F 1/01

(52) U.S. Cl. CPC G02F 1/133638; G02F 1/0136

(57) ABSTRACT

An optical system forming an image of light from a display element includes a modulation unit individually polarization-modulating light from each portion of the display element so that the light from each portion of the display element becomes any polarized light of a plurality of polarized light beams having different polarization directions, and an optical path portion through which the light polarization-modulated by the modulation unit passes, in which the optical path portion is configured such that an optical path length of the light passing through the optical path portion varies depending on a polarization direction when the light is incident on the optical path portion.

### FIELD

The present disclosure relates to an optical system and a display device.

### BACKGROUND

A technique for coping with a mismatch between convergence and accommodation in a head mount display (HMD) or the like has been proposed. For example, Patent Literature 1 discloses a technique for moving a liquid crystal display in an optical axis direction so that a convergence angle and a diopter coincide with each other.

### CITATION LIST

### Patent Literature

Patent Literature 1: JPH0787422A

### SUMMARY

### Technical Problem

When a display element such as a liquid crystal display is moved in the optical axis direction, the size of the device increases accordingly.

One aspect of the present disclosure is to suppress an increase in size of a device while coping with a mismatch between convergence and accommodation.

### Solution to Problem

An optical system according to one aspect of the present disclosure is an optical system forming an image of light from a display element, the optical system includes: a modulation unit individually polarization-modulating light from each portion of the display element so that the light from each portion of the display element becomes any polarized light of a plurality of polarized light beams having different polarization directions; and an optical path portion through which the light polarization-modulated by the modulation unit passes, wherein the optical path portion is configured such that an optical path length of the light passing through the optical path portion varies depending on a polarization direction when the light is incident on the optical path portion.

A display device according to one aspect of the present disclosure includes: a display element; and an optical system forming an image of light from the display element, wherein the optical system includes: a modulation unit individually polarization-modulating light from each portion of the display element so that the light from each portion of the display element becomes any polarized light of a plurality of polarized light beams having different polarization directions; and an optical path portion through which the light polarization-modulated by the modulation unit passes, and the optical path portion is configured such that an optical path length of the light passing through the optical path portion varies depending on a polarization direction when the light is incident on the optical path portion.

### BRIEF DESCRIPTION OF DRAWINGS

FIG. 1 is a view illustrating an example of a schematic configuration of a display device 1 according to an embodiment.

FIG. 2 is a view illustrating an example of a schematic configuration of a modulation unit 5.

FIG. 3 is a view illustrating an example of a schematic configuration of an optical path portion 6.

FIG. 4 is a view illustrating an example of a polarization direction of light in an optical system 3.

FIG. 5 is a view illustrating an example of a schematic configuration of the display device 1 according to a modification.

FIG. 6 is a view illustrating an example of a schematic configuration of an optical path portion 8.

FIG. 7 is a view illustrating an example of an optical path length of the optical path portion 8.

FIG. 8 is a view illustrating an example of a schematic configuration of the display device 1 according to a modification.

FIG. 9 is a view illustrating an example of polarization modulation by the modulation unit 5 and a modulation unit 5-2.

FIG. 10 is a view illustrating an example of the polarization direction of light in the optical system 3.

FIG. 11 is a view illustrating an example of a schematic configuration of the modulation unit 5.

FIG. 12 is a view illustrating an example of polarization modulation by the modulation unit 5.

FIG. 13 is a view illustrating an example of a schematic configuration of the display device 1 according to a modification.

### DESCRIPTION OF EMBODIMENTS

Hereinafter, embodiments of the present disclosure will be described in detail with reference to the drawings. In each of the following embodiments, overlapped description is omitted by assignment of the same reference sign to the same elements.

The present disclosure will be described in the following order of items.
0. Introduction
1. Embodiment
2. Modification
3. Examples of effects

### 0. Introduction

For example, in an optical system such as an HMD for virtual reality (VR), it is important to cope with a mismatch between convergence and accommodation in which a focus of an eye and binocular parallax are different. As an idea, it is conceivable to drive a focusing mechanism so as to give a virtual image position in a line-of-vision direction detected by eye sensing. However, extremely precise eye sensing is required. In the focusing mechanism that moves the display element as in Patent Literature 1, the size of the device increases. As another idea, there is a technique of using a plurality of panels each of which gives a different virtual image position, but there is still a problem such as causing an increase in size of the device.

According to the disclosed technique, it is possible to individually adjust a virtual image position corresponding to light from each portion (each position) of a display element, thereby addressing a mismatch between convergence and accommodation. Since eye sensing is not essential and the focusing mechanism is not required, it is possible to reduce the size and weight of the device. The possibility of being able to provide natural VR with less discomfort and less motion sickness than before is also increased.

### 1. Embodiment

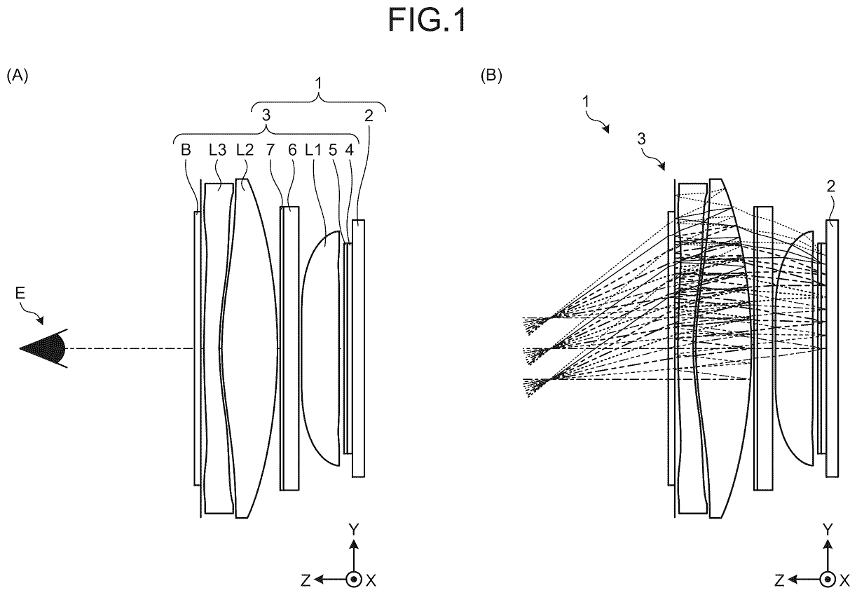

FIG. 1 is a view illustrating an example of a schematic configuration of a display device 1 according to an embodiment. The display device 1 is, for example, an HMD that presents a video such as VR, and is used by being worn on the head of a user. The video may be understood to have a meaning including an image, and the video and the image may be appropriately read within the scope having no contradiction. An eye of the user is referred to and illustrated as an eye E of the user. A video presented by the display device 1 is observed by the eye E of the user.

In the drawing, an XYZ coordinate system is illustrated. The display device 1 and the eye E of the user are positioned in this order in a Z-axis positive direction. Each element of the display device 1 extends in an XY plane direction and has a thickness in a Z-axis direction. (A) and (B) of FIG. 1 schematically illustrate a side surface (which may be a cross section) of the display device 1 as viewed in an X-axis direction. In (B) of FIG. 1, several light paths are schematically illustrated.

In the present disclosure, polarized light polarized in the X-axis direction is also referred to as X-polarized light. Polarized light polarized in a Y-axis direction is also referred to as Y-polarized light. Polarized light polarized in a direction of 45 degrees with respect to the X-axis direction and Y-axis direction is also referred to as 45 degree polarized light. Polarized light includes linearly polarized light and circularly polarized light; however, unless otherwise specified, the term “polarized light” may be understood to mean linearly polarized light.

The display device 1 includes a display element 2 and an optical system 3. The display element 2 and the optical system 3 are disposed in this order in the Z-axis positive direction.

The display element 2 emits light constituting a video. The display element 2 is a display panel having a display surface on a Z-axis negative direction side with the XY plane direction as a plane direction. The display element 2 includes, for example, an organic light emitting diode (OLED), a liquid crystal (LC), a light emitting diode (LED), and the like.

The display element 2 includes a plurality of portions each independently controlled to emit light. Typically, one portion of the display clement 2 is one pixel of the display element 2.

The optical system 3 forms an image of light from the display element 2. The optical system 3 includes a polarizing plate 4, a modulation unit 5, an optical path portion 6, a polarizing plate 7, and other optical systems. Examples of the other optical systems include a lens L1, a lens L2, a lens L3, and a flat plate B. The polarizing plate 4, the modulation unit 5, the lens L1, the optical path portion 6, the polarizing plate 7, the lens L2, the lens L3, and the flat plate B are disposed in this order in the Z-axis positive direction. The light from the display element 2 passes through these elements in order, and is imaged so that the user observes a virtual image with the eye E.

The polarizing plate 4 is disposed between the display element 2 and the modulation unit 5. The polarizing plate 4 is, for example, a polarizer, a wire grid polarizer, or the like, and allows only predetermined polarized light out of light beams from the display element 2 to pass therethrough. Thus, polarized light incident on the modulation unit 5 can be limited. For example, it is effective in a case where the display element 2 includes an OLED that emits light including various types of polarized light, or the like. In a case where the display element 2 includes an LCD that emits only light including specific polarized light, or the like, the polarizing plate 4 may be omitted. Hereinafter, unless otherwise specified, the predetermined polarized light passed by the polarizing plate 4 is assumed to be the Y-polarized light.

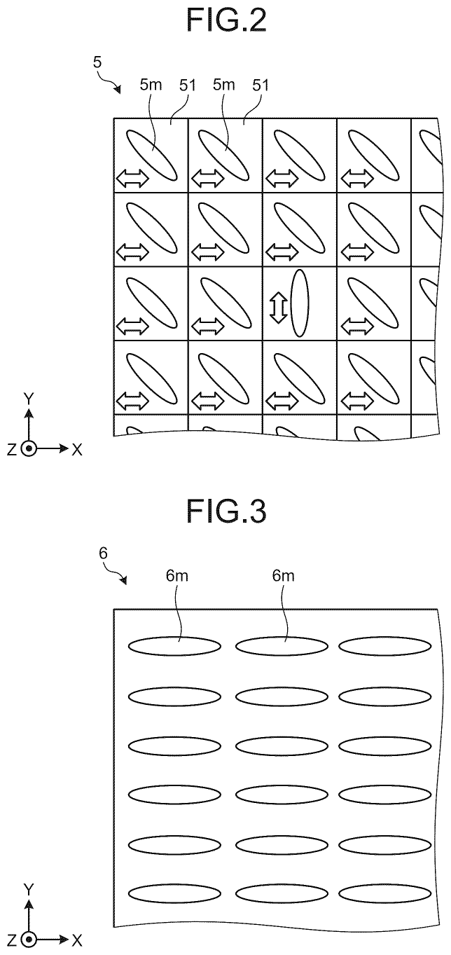

The modulation unit 5 polarization-modulates light from the display element 2 (light from the polarizing plate 4 in this example). The modulation unit 5 individually polarization-modulates light from each portion of the display element 2 so that the light from each portion of the display element 2 becomes any polarized light of a plurality of polarized light beams having different polarization directions. Examples of the plurality of polarized light beams include X-polarized light and Y-polarized light. Unless otherwise specified, the modulation unit 5 polarization-modulates light from each portion of the display element 2 into either X-polarized light or Y-polarized light. The modulation unit 5 will be described also with reference to FIG. 2.

FIG. 2 is a view illustrating an example of a schematic configuration of the modulation unit 5. The modulation unit 5 as viewed in the Z-axis negative direction is schematically illustrated. In the drawing, an outlined arrow extending in the X-axis direction schematically indicates X-polarized light. An outlined arrow extending in the Y-axis direction schematically indicates Y-polarized light. For example, the modulation unit 5 has the same configuration as the configuration in which a polarizing plate is removed from a modulation liquid crystal panel in which liquid crystal molecules are aligned in the plane.

The modulation unit 5 includes a plurality of liquid crystal units 51. Each liquid crystal unit 51 corresponds to each portion of the display element 2. Light from a corresponding portion of each portion of the display element 2 is incident on each of the plurality of liquid crystal units 51. One or more liquid crystal molecules 5m are disposed in each liquid crystal unit 51. Light from each portion of the display element 2 passes through the liquid crystal molecule 5m disposed in the corresponding liquid crystal unit 51.

Each liquid crystal unit 51 is individually driven. For example, the voltage application to each liquid crystal unit 51 is individually controlled. The driving of the liquid crystal unit 51 includes changing a state of the liquid crystal molecule 5m disposed in the liquid crystal unit 51. An example of the state of the liquid crystal molecule 5m is an orientation of the liquid crystal molecule 5m.

In the example illustrated in FIG. 2, the liquid crystal molecule 5m has an orientation of 45 degrees with respect to the X axis and the Y axis in a state where no voltage is applied and the liquid crystal unit is not driven (default state). It is assumed that an applied phase difference is a ½ wavelength. When Y-polarized light from the polarizing plate 4 is incident on the liquid crystal unit 51, the Y-polarized light is converted into X-polarized light and the X-polarized light is then emitted. On the other hand, the liquid crystal molecule 5m has an orientation of 90 degrees with respect to the X axis (0 degrees with respect to the Y axis) in a state where a voltage is applied and the liquid crystal unit is driven (driving state). Y-polarized light incident on the liquid crystal unit 51 is directly emitted as Y-polarized light.

For example, with the above-described configuration, the modulation unit 5 individually polarization-modulates light having passed through each liquid crystal unit 51, that is, light from each portion of the display element 2 into either X-polarized light or Y-polarized light.

According to the principle described later, the selection of X-polarized light and Y-polarized light here gives a change in the virtual image position (depth).

The modulation unit 5 may include a plurality of layers each of which has a different phase amount and phase axis angle so that an applied phase difference of a ½ wavelength is achieved over a wide band including RGB, for example.

Returning to FIG. 1, the light from the modulation unit 5 passes through the lens L1. The illustrated lens L1 is an aspheric lens and is provided between the modulation unit 5 and the optical path portion 6. The lens L1 may be designed such that the incident angle is larger than the output angle (for example, by 5 degrees or more). It is possible to secure the inward bending amount of the principal light beam having the maximum angle of view and to adjust the diopter while maintaining image-plane characteristics. The light having passed through the lens L1 is incident on the optical path portion 6.

The optical path portion 6 is a portion through which the light polarization-modulated by the modulation unit 5 (the light from the lens L1 in this example) passes. The optical path portion 6 is configured such that an optical path length of the light passing through the optical path portion 6 varies depending on a polarization direction when the light is incident on the optical path portion 6. For example, the optical path portion 6 is configured such that a refractive index of the light passing through the optical path portion 6 varies depending on the polarization direction of the light. This will be described with reference to FIG. 3.

FIG. 3 is a view illustrating an example of a schematic configuration of the optical path portion 6. The optical path portion 6 as viewed in the Z-axis negative direction is schematically illustrated. The optical path portion 6 includes a plurality of liquid crystal molecules 6m. The plurality of liquid crystal molecules 6m are disposed such that a refractive index of light passing therethrough varies depending on the polarization direction of the light. The plurality of liquid crystal molecules 6m are, for example, polymer liquid crystals, and are disposed in the same direction.

In the example illustrated in FIG. 3, the plurality of liquid crystal molecules 6m have an orientation of 0 degrees with respect to the X axis (an orientation of 90 degrees with respect to the Y axis). The optical path portion 6 gives different refractive indexes to X-polarized light and Y-polarized light. Specifically, the refractive index of the Y-polarized light is higher than the refractive index of the X-polarized light. For example, the refractive index of the X-polarized light is 1.52, and the refractive index of the Y-polarized light is 1.77. A refractive index difference is 0.25.

Due to the refractive index difference, the optical path length of the X-polarized light and the optical path length of the Y-polarized light passing through the optical path portion 6 are different from each other. In the above example, the optical path length of the Y-polarized light is longer than the optical path length of the X-polarized light. That is, the optical path length of the light from each portion of the display element 2 can be changed by combining polarization modulation by the modulation unit 5 and the optical path portion 6 described above. The optical path length of the light passing through the optical path portion 6 corresponds to a focus adjustment interval of the optical system 3, and as a result, gives a change in the virtual image position (diopter). For example, a virtual image formed by light having a short optical path length is observed to be located on the near side, and a virtual image formed by light having a long optical path length is observed to be located on the far side. The virtual image position can be adjusted.

A difference between the virtual image position in the case of the X-polarized light and the virtual image position in the case of the Y-polarized light is caused by the thickness (length in the Z-axis direction) of the optical path portion 6. The thickness of the optical path portion 6 is designed such that a desired difference between the two virtual image positions is obtained. For example, as described above, when the refractive index difference is 0.25 and the optical path length for setting the difference between the two virtual image positions to 0.6D (D is a diopter value) is 0.664 m (air length), the thickness of the optical path portion 6 is designed to be 2.655 mm (0.644/0.25).

Returning to FIG. 1, the polarizing plate 7 is disposed on a side opposite to the modulation unit 5 with the optical path portion 6 (the optical path portion 6 and the lens L1 in this example) interposed therebetween, and rectifies the light from the optical path portion 6 into predetermined polarized light. As a result, the final polarized light of the light after passing through the optical path portion 6 can be unified. For example, a configuration including the lens L1, the lens L2, and the lens L3 (triple-pass configuration) can be adopted. Unless otherwise specified, it is assumed that the polarizing plate 7 rectifies the light from the optical path portion 6 such that the light from the optical path portion 6 becomes 45 degree polarized light. The polarizing plate 7 is disposed to have an azimuth angle of 45 degrees, for example.

The light from the polarizing plate 7 passes through the lens L2, the lens L3, and the flat plate B. The lens L2 and the lens L3 are aspheric lenses designed to form an image of the light from the polarizing plate 7, and are provided in order on a side opposite to the modulation unit 5 with the optical path portion 6 and the polarizing plate 7 interposed therebetween. The lens L2 may be configured to have positive refractive power (focal length>0), and the lens L3 may be configured to have negative refractive power (focal length<0). Aberration such as chromatic aberration can be easily adjusted. The refractive index of the lens L3 at the d-line may be larger than the refractive index of the lens L2. The Abbe number of the lens L3 at the d-line may be smaller than the Abbe number of the lens L2. The chromatic aberration of magnification can be effectively corrected. The flat plate B is a transparent flat plate that transmits light from the lens L3. The surface (for example, the surface on the Z-axis negative direction side) of the flat plate B may be a semi-transmission reflection surface that reflects a part of the incident light and allows a part of the incident light to pass therethrough. For example, a half mirror may be used.

The illustrated optical system 3 has a triple-pass configuration in which the light from the display clement 2 passes through three lenses, i.e., the lens L1, the lens L2, and the lens L3. With such a configuration, a reduction in thickness and size of the optical system 3 is achieved.

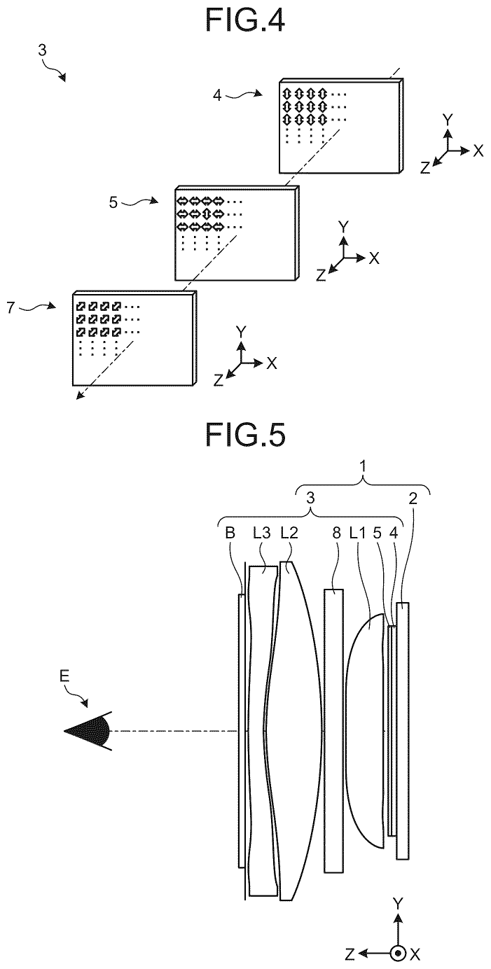

FIG. 4 is a view illustrating an example of a polarization direction of light in the optical system 3. The polarization direction of light after passing through each of the polarizing plate 4, the modulation unit 5, and the polarizing plate 7 among the components of the optical system 3 is schematically indicated by an outlined arrow. The light having passed through the polarizing plate 4 is Y-polarized light. The light having passed through the modulation unit 5 is either X-polarized light or Y-polarized light. The light having passed through the polarizing plate 7 is 45 degree polarized light.

According to the display device 1 including the optical system 3 described above, the optical path length of the light from each portion of the display element 2 can be changed by the combination of polarization modulation by the modulation unit 5 and the optical path portion 6. As a result, since the virtual image position can be adjusted, it is possible to cope with a mismatch between convergence and accommodation. Since eye sensing is not essential and the focusing mechanism is not required, it is possible to reduce the size and weight. Therefore, it is possible to suppress an increase in size of the device while coping with a mismatch between convergence and accommodation.

Since processing related to eye sensing and driving of the focusing mechanism becomes unnecessary, a signal processing load is also reduced. The amount of heat generation is reduced, and long-term operation by a battery is also possible.

More beautiful video presentation is also possible. In particular, there is an advantage that it is easy to cope with a video in which a front image and a back image are complicatedly mixed. For example, in a method in which a plurality of panels are used for a VR optical system, it is necessary to bring the positions of the panels substantially close to each other in the Z-axis direction, and aberration correction becomes difficult. In the case of combining the two sheets with a beam splitter, there is no back focus at a high resolution wide viewing angle, and the two sheets cannot be incorporated. Such a problem can also be addressed in the display device 1 according to the embodiment.

The influence of the aberration by the optical path portion 6 is slight. For example, the contrast characteristics with respect to the spatial frequency of each of the portions adjusted to different virtual image positions in the video fall within a practically acceptable range. The same applies to the chromatic aberration of magnification.

### 2. Modification

The disclosed technique is not limited to the above embodiments. Some modifications will be described. For example, the configuration of the optical path portion may be different from the configuration of the optical path portion 6 described above. This will be described with reference to FIGS. 5 to 8.

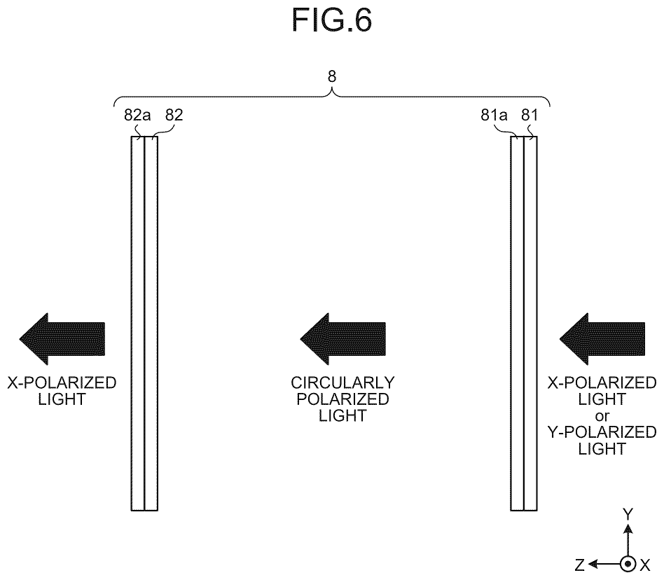

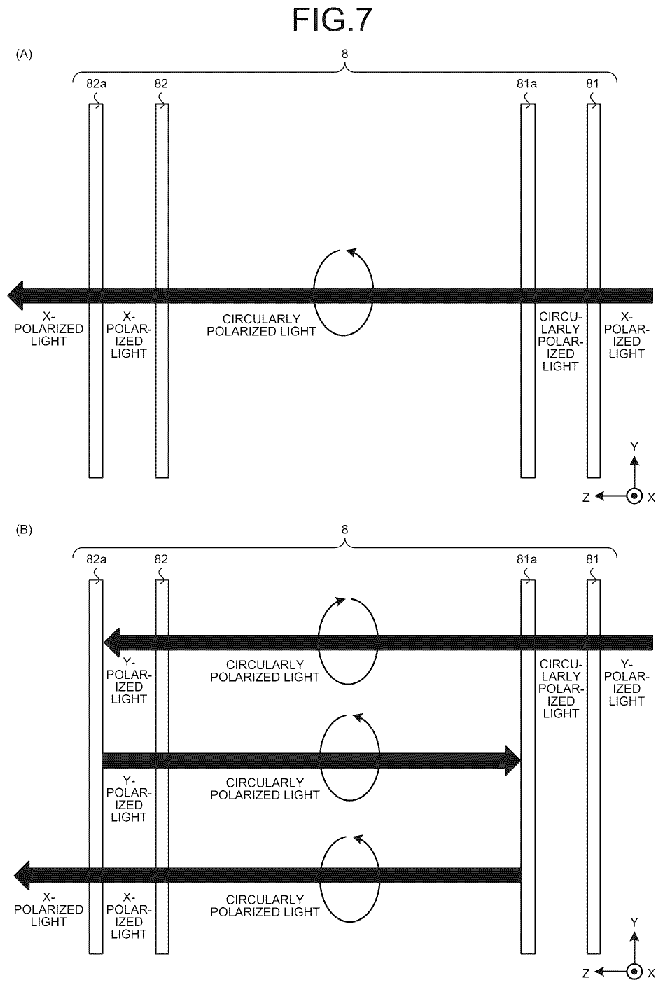

FIG. 5 is a view illustrating an example of a schematic configuration of the display device 1 according to a modification. In the example illustrated in FIG. 5, the optical system 3 of the display device 1 includes an optical path portion 8 instead of the optical path portion 6 (FIG. 1) described above. Similarly to the optical path portion 6, the optical path portion 8 is configured such that an optical path length of the light passing through the optical path portion 8 varies depending on a polarization direction when the light is incident on the optical path portion 8. However, the specific configuration of the optical path portion 8 is different from the configuration of the optical path portion 6. The optical path portion 8 will be described also with reference to FIGS. 6 and 7.

FIG. 6 is a view illustrating an example of a schematic configuration of the optical path portion 8. The optical path portion 8 includes a wavelength plate 81, a half mirror 81a, a wavelength plate 82, and a reflective polarizing plate 82a. In the Z-axis positive direction, the wavelength plate 81, the half mirror 81a, the wavelength plate 82, and the reflective polarizing plate 82a are disposed in this order. In this example, the wavelength plate 81 and the half mirror 81a are disposed to be stuck to each other. The half mirror 81a and the wavelength plate 82 are disposed to be mutually spaced. The wavelength plate 82 and the reflective polarizing plate 82a are disposed to be stuck to each other. A traveling direction of light passing through the optical path portion 8 is schematically indicated by a black arrow.

The wavelength plate 81 is a first wavelength plate that converts linearly polarized light from the modulation unit 5 into circularly polarized light according to a polarization direction of the linearly polarized light. The wavelength plate 81 is, for example, a ¼ wavelength plate (QWP), and converts the X-polarized light or the Y-polarized light having passed through the wavelength plate 81 into circularly polarized light. A rotation direction of the circularly polarized light obtained by the X-polarized light passing through the wavelength plate 81 and a rotation direction of the circularly polarized light obtained by the Y-polarized light passing through the wavelength plate 81 are opposite to each other.

The half mirror 81a is disposed between the wavelength plate 81 and the wavelength plate 82, reflects a part of the incident light, and allows a part of the incident light to pass therethrough. A part of the circularly polarized light from the wavelength plate 81 passes through the half mirror 81a and is directed to the wavelength plate 82.

The wavelength plate 82 is a second wavelength plate that converts circularly polarized light from the wavelength plate 81, more specifically, circularly polarized light from the half mirror 81a in this example, into linearly polarized light according to a rotation direction of the circularly polarized light. The wavelength plate 82 is, for example, a ¼ wavelength plate, and converts the circularly polarized light from the wavelength plate 81 into X-polarized light or Y-polarized light.

The reflective polarizing plate 82a is disposed on a side opposite to the wavelength plate 81 (the wavelength plate 81 and the half mirror 81a in this example) with the wavelength plate 82 interposed therebetween. The reflective polarizing plate 82a passes predetermined linearly polarized light and reflects other linearly polarized light. In this example, the reflective polarizing plate 82a transmits the X-polarized light and reflects the Y-polarized light. As a result, only the X-polarized light is emitted from the optical path portion 8.

FIG. 7 is a view illustrating an example of an optical path length of the optical path portion 8. For convenience of description, the wavelength plate 81 and the half mirror 81a are illustrated apart from each other. The rotation direction of the circularly polarized light is schematically illustrated by a circular arrow.

In (A) of FIG. 7, an optical path when the X-polarized light is incident on the optical path portion 8 is schematically indicated by a black arrow. The X-polarized light passes through the wavelength plate 81 and becomes circularly polarized light. A part of the circularly polarized light passes through the half mirror 81a and passes through the wavelength plate 83 to become X-polarized light. The X-polarized light passes through the reflective polarizing plate 84 and then emitted. Light passing through the optical path portion 8 passes between the half mirror 81a and the reflective polarizing plate 82a only once (one-pass).

In (B) of FIG. 7, an optical path when the Y-polarized light is incident on the optical path portion 8 is schematically indicated by a black arrow. For easy understanding, the optical paths indicated by the black arrows are illustrated at different positions in the Y-axis direction, but the optical paths may be located at the same position in the Y-axis direction. The Y-polarized light passes through the wavelength plate 81 and becomes circularly polarized light. A part of the circularly polarized light passes through the half mirror 81a and further passes through the wavelength plate 83 to become Y-polarized light. The Y-polarized light is reflected by the reflective polarizing plate 84, passes through the wavelength plate 83, and becomes circularly polarized light. A part of the circularly polarized light is reflected by the half mirror 81a and passes through the wavelength plate 83 to become X-polarized light. The X-polarized light passes through the reflective polarizing plate 84 and then emitted. Light passing through the optical path portion 8 passes between the half mirror 81a and the reflective polarizing plate 82a three times (three-pass).

In the above example, the optical path length of the light that has been Y-polarized light is longer than the optical path length of the light that has been X-polarized light when entering the optical path portion 8. That is, the optical path length of the light from each portion of the display element 2 can be changed by combining polarization modulation by the modulation unit 5 and the optical path portion 8 described above. It is also possible to adjust the virtual image position in this manner. For example, when the optical path length for setting the difference between the two virtual image positions to 0.6D is 0.664 m (air length), the thickness of the optical path portion 8 is designed to be 0.322 mm (0.644/2). It is most desirable that the transmission efficiency and the reflection efficiency of the half mirror 81a are near 38% and 62%, respectively. This is because the efficiency 38% of the one-pass optical path and the efficiency 62%×62%≈38% at the time of triple-pass substantially coincide with each other.

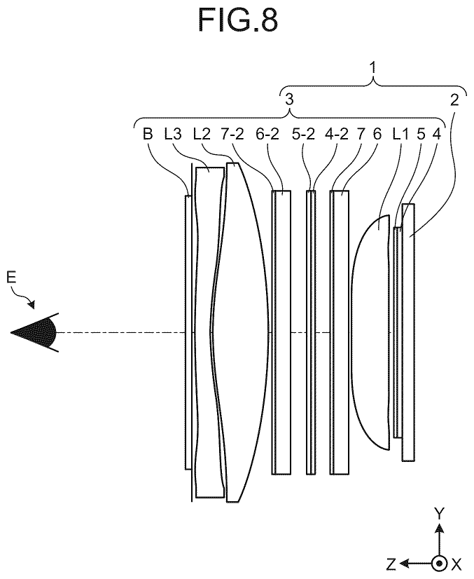

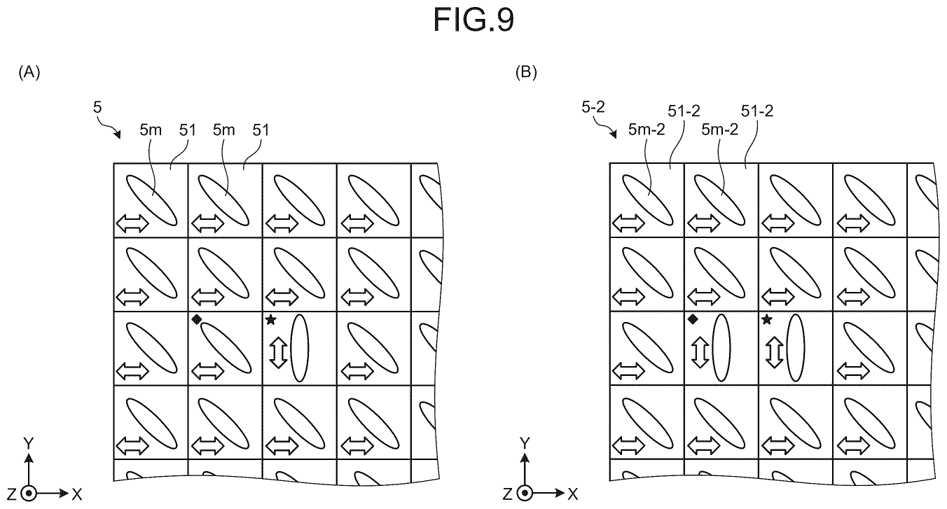

In the above embodiment, a method (for example, bifocal point VR) of giving two different virtual image positions by a combination of polarization modulation by the modulation unit 5 and the optical path portion 6 (or the optical path portion 8) has been described. However, it is also possible to give three or more different virtual image positions. This will be described with reference to FIGS. 8 and 9.

FIG. 8 is a view illustrating an example of a schematic configuration of the display device 1 according to a modification. The illustrated display device 1 includes two sets of the polarizing plate 4, the modulation unit 5, the optical path portion 6, and the polarizing plate 7. The polarizing plate 4, the modulation unit 5, the optical path portion 6, and the polarizing plate 7 according to the second set are referred to and illustrated as a polarizing plate 4-2, a modulation unit 5-2, an optical path portion 6-2, and a polarizing plate 7-2. In the Z-axis positive direction, the polarizing plate 4-2, the modulation unit 5-2, the optical path portion 6-2, and the polarizing plate 7-2 are disposed in this order between the polarizing plate 7 and the lens L2.

The polarizing plate 4-2, the modulation unit 5-2, the optical path portion 6-2, and the polarizing plate 7-2 may have the same configurations as those of the polarizing plate 4, the modulation unit 5, the optical path portion 6, and the polarizing plate 7. The thickness of the optical path portion 6-2 may be the same as or different from the thickness of the optical path portion 6-1. Light to be polarization-modulated by the modulation unit 5-2 is light from each portion of the display element 2 and is light that has passed through the optical path portion 6 (light that has also passed through the polarizing plate 7 and the polarizing plate 4-2 in this example). Light passing through the optical path portion 6-2 is light polarization-modulated by the modulation unit 5-2.

Two different virtual image positions can be given by a combination of polarization modulation by the modulation unit 5 and the optical path portion 6. Two different virtual image positions can also be given by a combination of polarization modulation by the modulation unit 5-2 and the optical path portion 6-2. These combinations allow three or more, up to four different virtual image positions to be given. This will be described with reference to FIG. 9.

FIG. 9 is a view illustrating an example of polarization modulation by the modulation unit 5 and the modulation unit 5-2. (A) of FIG. 9 illustrates an example of polarization modulation by the modulation unit 5. (B) of FIG. 9 illustrates an example of polarization modulation by the modulation unit 5-2. Liquid crystals and liquid crystal molecules of the modulation unit 5-2 are referred to and illustrated as liquid crystal units 51-2 and liquid crystal molecules 5m-2.

In FIG. 9, a rhombus mark and a star mark are attached to two liquid crystal units of interest among the plurality of liquid crystal units 51. Similarly, a rhombus mark and a star mark are attached to two liquid crystal units among the plurality of liquid crystal units 51-2. The liquid crystal unit 51 and the liquid crystal unit 51-2 provided with the same mark correspond to the same portion of the display element 2.

As illustrated in (A) of FIG. 9, in the modulation unit 5, the liquid crystal unit 51 with a star mark is driven, and the liquid crystal molecule 5m has an orientation of 90 degrees with respect to the X axis (0 degrees with respect to the Y axis). The light having passed through the liquid crystal unit 51 passes through the optical path portion 6 as Y-polarized light. The light having passed through the other liquid crystal units 51 passes through the optical path portion 6 as X-polarized light.

As illustrated in (B) of FIG. 9, in the modulation unit 5-2, the liquid crystal unit 51-2 with a rhombus mark and the liquid crystal unit 51-2 with a star mark are driven, and the liquid crystal molecules 5m have an orientation of 90 degrees with respect to the X axis (0 degrees with respect to the Y axis). The light having passed through these liquid crystal units 51-2 passes through the optical path portion 6-2 as Y-polarized light. The light having passed through the other liquid crystal units 51-2 passes through the optical path portion 6-2 as X-polarized light.

In the above example, the optical path of the light having passed through the liquid crystal unit 51 and the liquid crystal unit 51-2 with a star mark is the longest. The optical path of the light having passed through the liquid crystal unit 51 and the liquid crystal unit 51-2 with a rhombus mark becomes long. The optical path of the light having passed through the other liquid crystal units 51 and liquid crystal units 51-2 is the shortest.

For example, a case where the refractive index difference in the optical path portion 6 is 0.25, the thickness of the optical path portion 6 is 0.8 mm, the refractive index difference in the optical path portion 6-2 is 0.25, and the thickness of the optical path portion 6-2 is 2.655 mm is considered. A difference between two virtual image positions obtained by the optical path portion 6-2 is 0.6 D. The difference is 0.8 D in total of the optical path portion 6 and the optical path portion 6-2. The light having passed through the liquid crystal unit 51 and the liquid crystal unit 51-2 with a star mark is Y-polarized light when entering the optical path portion 6 and when entering the optical path portion 6-2, and the optical path length thereof is the longest. For example, a virtual image position of 0.5D is given. On the other hand, the light having passed through the liquid crystal unit 51 and the liquid crystal unit 51-2 with a rhombus mark is X-polarized light when entering the optical path portion 6 and is Y-polarized light when entering the optical path portion 6-2. A virtual image position of 0.7 D is given. The light having passed through the other liquid crystal units 51 and liquid crystal units 51-2 is X-polarized light when entering the optical path portion 6 and when entering the optical path portion 6-2, and the optical path length thereof is the shortest. A virtual image position of 1.3 D is given.

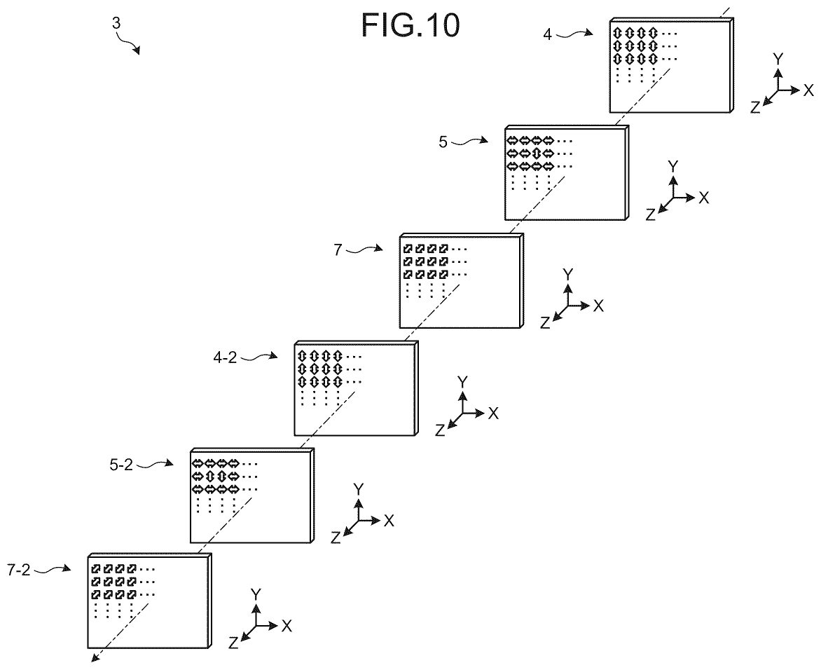

FIG. 10 is a view illustrating an example of the polarization direction of light in the optical system 3. The polarization direction of light after passing through each of the polarizing plate 4, the modulation unit 5, the polarizing plate 7, the polarizing plate 4-2, the modulation unit 5-2, and the polarizing plate 7-2 among the components of the optical system 3 is schematically indicated by an outlined arrow. The light having passed through the polarizing plate 4 is Y-polarized light. The light having passed through the modulation unit 5 is either X-polarized light or Y-polarized light. The light having passed through the polarizing plate 7 is 45 degree polarized light. The light having passed through the polarizing plate 4-2 is Y-polarized light. The light having passed through the modulation unit 5-2 is either X-polarized light or Y-polarized light. The light having passed through the polarizing plate 7-2 is 45 degree polarized light.

Although not mentioned above, polarization modulation may be performed such that the Y-polarized light is obtained by the modulation unit 5 and the X-polarized light is obtained by the modulation unit 5-2. The light polarized in this manner may give another virtual image position. As a result, up to four different virtual image positions can be given (for example, four-focal point VR).

For example, by disposing two sets of the polarizing plate 4, the modulation unit 5, the optical path portion 6, and the polarizing plate 7 as described above, it is possible to give more virtual image positions than in the case of one set. Naturally, the number of sets can be set to three or more to give more virtual image positions.

In one embodiment, the wavelength band may be widened by staking a wavelength plate on the modulation unit 5. This will be described with reference to FIG. 11.

FIG. 11 is a view illustrating an example of a schematic configuration of the modulation unit 5. A wavelength plate 5a is provided for the modulation unit 5. In this example, the wavelength plate 5a is stacked on the surface of the modulation unit 5 on the Z-axis positive direction side. The wavelength plate 5a is, for example, a ½ wavelength plate having an azimuth axis of 114.5 degrees. The wavelength characteristics of the modulation unit 5 itself, that is, the liquid crystal unit 51 in which the liquid crystal molecule 5m is disposed can be improved. For example, equivalent change modulation can be performed over a wide wavelength band such as an RGB band. RGB efficiency and crosstalk can be improved.

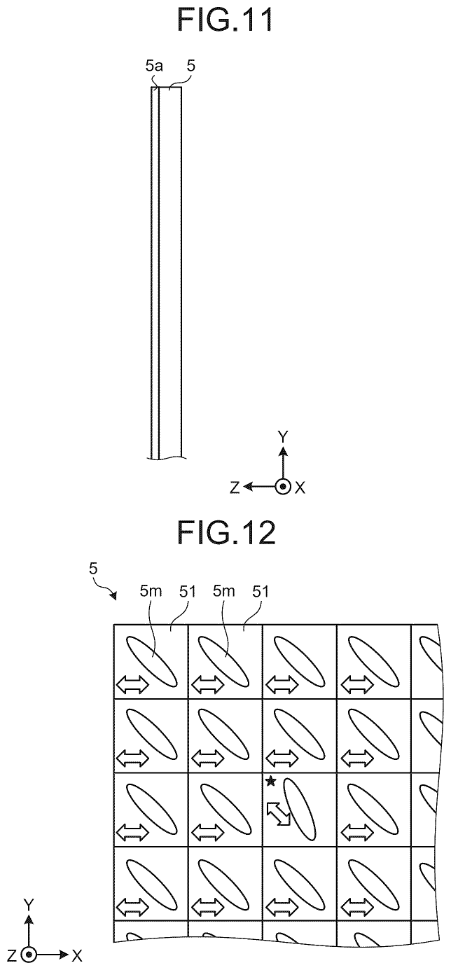

In one embodiment, the plurality of polarized light beams obtained by the polarization modulation of the modulation unit 5 may include polarized light polarized in a direction between the X-axis direction and the Y-axis direction. This will be described with reference to FIG. 12.

FIG. 12 is a view illustrating an example of polarization modulation by the modulation unit 5. A star mark is attached to the liquid crystal unit 51 in the driving state. The liquid crystal molecule 5m has an orientation of 67.5 degrees with respect to the X axis (22.5 degrees with respect to the Y axis). Y-polarized light incident on the liquid crystal unit 51 is polarization-modulated to be 45 degree polarized light. When the light passes through the optical path portion 6, since the optical path length in the optical path portion 6 is different between the X-polarized light and the Y-polarized light, it behaves as if there are optical path lengths in both cases. Using the numerical values of the previous embodiment, both the virtual image position of 0.5 D and the virtual image position of 1.1 D are given. Strictly speaking, each virtual image position is superimposed, but due to a psychological effect, the user can view a video as if a virtual image position of 0.8 D which is an intermediate position between these virtual image positions, exists. By mixing different virtual image positions in this manner, it is also possible to give a virtual image position in a pseudo intermediate state.

In the above embodiment, a case where the optical system 3 has the configuration of the triple-pass system including the lens L1, the lens L2, and the lens L3 has been described as an example. However, the configuration of the triple-pass system is not essential, and various other configurations may be adopted. Examples of other configurations include a Fresnel type and a two-panel configuration.

The D value is not limited to the values described so far, and may be designed to various arbitrary values. For example, although 0.5 D is used as a reference in the previous embodiment, a design based on OD may be performed.

Since air portions at both ends of the optical path portion 6 (or the optical path portion 6 and the polarizing plate 7) in the Z-axis direction are portions where the virtual image position can be changed, diopter adjustment may be performed by adjusting the length of this portion. The diopter adjustment may be simply used for vision correction such as myopia and hyperopia. First, the lengths of the air portions at both ends of the optical path portion 6 may be roughly adjusted, and then the virtual image position may be adjusted by the combination of the modulation unit 5 and the optical path portion 6 as described above. For example, it is possible to reduce an uncomfortable feeling in a close view mixed with a distant view while further expanding the virtual image correction range. Since the lengths of the air portions at both ends of the optical path portion 6 and the virtual image position (diopter) are not in a simple proportional relationship, they may be designed with reference to a data table or a calculation formula prepared in advance. The same may apply to the case of determining the polarization direction by the modulation unit 5.

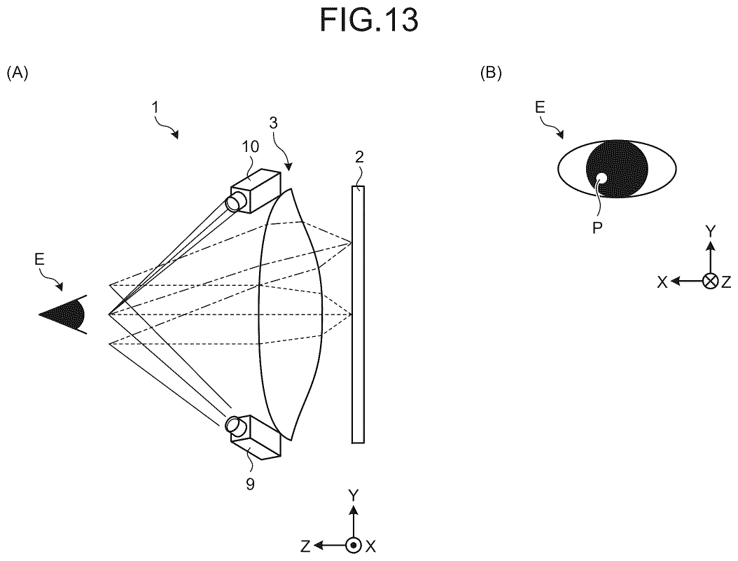

In one embodiment, a portion looked at by the user in the video may be specified (identified etc.) by eye sensing. This will be described with reference to FIG. 13.

FIG. 13 is a view illustrating an example of a schematic configuration of the display device 1 according to a modification. (A) of FIG. 13 illustrates a schematic configuration of the display device 1. The configurations of the display element 2 and the optical system 3 are illustrated in a simplified manner. The display device 1 further includes a projector 9 and a camera 10 for eye sensing. The projector 9 and the camera 10 are disposed at positions that do not block light from the display element 2 on which the optical system 3 forms an image. The projector 9 emits light toward the pupil of a user U, for example. An example of the light is infrared light. The camera 10 detects light reflected by the pupil of the user U and thereby captures the eye E. A portion looked at by the user in the video is specified on the basis of the captured eye E of the user. (B) of FIG. 13 illustrates an example of the captured eye E of the user. On the basis of the capturing result, an object point P on the eye E (on the pupil), for example, a Purkinje image is acquired, whereby a portion looked at by the user in the video is specified. The virtual image position may be adjusted on the basis of a result of such eye sensing.

In one embodiment, an interval (pitch) between the liquid crystal units 51 adjacent to each other in the modulation unit 5 may be coarser than an interval (for example, pixel pitch) between respective portions of the display element 2. For example, the display element 2 may have 4K resolution (3840×2160), and the resolution of the modulation unit 5 may be HD (1280×720), FHD (1920×1080), or the like. This is because while the display element 2 directly affects the image quality, the modulation unit 5 only changes the virtual image position, and there is no problem even when the fineness is relatively small. For example, even when the aperture ratio of the transmissive liquid crystal of the modulation unit 5 is not so high, the low resolution can compensate for the low aperture ratio. The position of the modulation unit 5 is shifted from the image focal point of the display element 2, and in this sense, it can be said that the modulation unit 5 is less required to have high resolution.

In the mode of FIG. 12 described above, instead of generating the polarized light in an intermediate state (polarized light other than the X-polarized light and the Y-polarized light), the ratio of the X-polarized light and the Y-polarized light may be switched in time series. In the optical path portion 6 of FIG. 1 and the like described above, a birefringent crystal having different dispersibility in XY may be disposed instead of stacking a liquid crystal polymer. Examples thereof include CaCO₃ crystal (calcite) and α-BaB2O4.

### 3. Examples of Effects

The technique described above is specified as follows, for example. The optical path portion 6 described below may be appropriately replaced with the optical path portion 8 within the scope having no contradiction. One of the disclosed techniques is the optical system 3. As described with reference to FIGS. 1 to 7 and the like, the optical system 3 forms an image of light from the display element 2. The optical system 3 includes the modulation unit 5 and the optical path portion 6. The modulation unit 5 individually polarization-modulates light from each portion of the display element 2 so that the light from each portion of the display element 2 becomes any polarized light of a plurality of polarized light beams having different polarization directions. The optical path portion 6 is a portion through which the light polarization-modulated by the modulation unit 5 passes. The optical path portion 6 is configured such that an optical path length of the light passing through the optical path portion 6 varies depending on a polarization direction when the light is incident on the optical path portion 6.

According to the optical system 3 described above, the optical path length of the light from each portion of the display element 2 can be changed by the combination of polarization modulation by the modulation unit 5 and the optical path portion 6. As a result, since the virtual image position can be adjusted, it is possible to cope with a mismatch between convergence and accommodation. For example, it is not necessary to move the display element 2 unlike Patent Literature 1, and an increase in size of the device can be suppressed accordingly. It is possible to suppress an increase in size of the device while coping with a mismatch between convergence and accommodation.

As described with reference to FIG. 2 and the like, the modulation unit 5 may include the plurality of liquid crystal units 51 in each of which the liquid crystal molecule 5m is disposed, the plurality of liquid crystal units 51 being individually driven, light from a corresponding portion of each portion of the display element 2 may be incident on each of the plurality of liquid crystal units 51, and the driving of each of the liquid crystal units 51 may include changing a state of the liquid crystal molecule 5m (for example, the orientation of the liquid crystal molecule 5m) disposed in each of the liquid crystal units 51. For example, the light from each portion of the display element 2 can be individually polarization-modulated by the modulation unit 5 having such a configuration.

As described with reference to FIG. 3 and the like, the optical path portion 6 may be configured such that a refractive index of the light passing through the optical path portion 6 varies depending on the polarization direction of the light. In this case, the optical path portion 6 may include the plurality of liquid crystal molecules 6m disposed in the same direction. For example, the optical path length of the light passing through the optical path portion 6 can vary depending on the polarization direction at the time of incidence by the optical path portion 6 having such a configuration.

As described with reference to FIGS. 5 to 7, the optical path portion 8 may include: the wavelength plate 81 (first wavelength plate) converting linearly polarized light from the modulation unit 5 into circularly polarized light according to a polarization direction of the linearly polarized light; the wavelength plate 82 (second wavelength plate) converting the circularly polarized light from the wavelength plate 81 into linearly polarized light according to a rotation direction of the circularly polarized light; the half mirror 81a disposed between the wavelength plate 81 and the wavelength plate 82; and the reflective polarizing plate 82a disposed on a side opposite to the wavelength plate 81 with the wavelength plate 82 interposed therebetween, allowing predetermined linearly polarized light to pass therethrough, and reflecting other linearly polarized light. For example, the optical path length of the light passing through the optical path portion 8 can also vary depending on the polarization direction at the time of incidence by the optical path portion 8 having such a configuration.

As described with reference to FIGS. 1 and 4 and the like, the optical system 3 may include the polarizing plate 4, the polarizing plate 4 being disposed between the display element 2 and the modulation unit 5 and allowing only predetermined polarized light out of light beams from the display element 2 to pass therethrough. Even when the display element 2 emits light including polarized light in various directions, the polarized light incident on the modulation unit 5 can be limited. For example, the display element 2 may include an organic light emitting diode (OLED).

As described with reference to FIG. 1 and the like, the optical system 3 may include the polarizing plate 7, the polarizing plate being disposed on a side opposite to the modulation unit 5 with the optical path portion 6 with the optical path portion interposed therebetween and rectifying the light from the optical path portion 6 into predetermined polarized light. As a result, the final polarized light after passing through the optical path portion 6 can be unified. The optical system 3 may include a plurality of lenses for forming an image of light from the display element 2, and the plurality of lenses may include: the lens L1 provided between the modulation unit 5 and the optical path portion 6; and the lens L2 and the lens L3 provided in order on a side opposite to the modulation unit 5 with the optical path portion 6 (or the optical path portion 6 and the polarizing plate 7) interposed therebetween. For example, such a triple-pass configuration can be adopted.

As described with reference to FIGS. 8 to 10 and the like, the optical system 3 may include the modulation unit 5-2 and the optical path portion 6-2. The modulation unit 5-2 is a second modulation unit that individually polarization-modulates light from each portion of the display element 2 and having passed through the optical path portion 6 so that the light from each portion of the display element 2 and having passed through the optical path portion 6 becomes any polarized light of a plurality of polarized light beams having different polarization directions. The optical path portion 6-2 is a second optical path portion through which the light polarization-modulated by the modulation unit 5-2 passes. The optical path portion 6-2 is configured such that an optical path length of the light passing through the optical path portion 6-2 varies depending on a polarization direction when the light is incident on the optical path portion 6-2. As a result, more different virtual image positions can be given than a case where only one modulation unit 5 and only one optical path portion 6 are given.

As described with reference to FIG. 11 and the like, the wavelength plate 5a may be stacked on the modulation unit 5. As a result, the wavelength band can be widened.

As described with reference to FIGS. 1 to 4 and the like, the display element 2 may extend in an XY plane direction, and the plurality of polarized light beams obtained by the polarization modulation of the modulation unit 5 may include X-polarized light polarized in an X-axis direction and Y-polarized light polarized in a Y-axis direction. For example, using such polarized light, the optical path length of light from each portion of the display element 2 can be changed to give different virtual image positions. As described with reference to FIG. 12 and the like, the plurality of polarized light beams may include polarized light polarized in a direction between the X-axis direction and the Y-axis direction. As a result, different virtual image positions are mixed so that it is possible to give a virtual image position in a pseudo intermediate state.

The display device 1 described with reference to FIGS. 1 to 7 and the like is also one of the disclosed techniques. The display device 1 includes the display element 2 and the optical system 3 that forms an image of light from the display element 2. The optical system 3 is as described above. Also with such a display device 1, as described above, it is possible to suppress an increase in size of the device while coping with a mismatch between convergence and accommodation.

As described with reference to FIG. 13 and the like, the display device 1 may include the camera 10 for eye sensing. For example, the virtual image position can be adjusted based on the result of the eye sensing.

The effects described in the present disclosure are merely examples and are not limited to the disclosed contents. There may be other effects.

The embodiments of the present disclosure have been described; however, the technical scope of the present disclosure is not limited to the embodiments described above as they are, and various modifications can be made within the scope not departing from the gist of the present disclosure. The components across the different embodiments and modifications may be combined with each other as appropriate.

The present technique can also take the following configurations.
(1) An optical system forming an image of light from a display element, the optical system comprising:
a modulation unit individually polarization-modulating light from each portion of the display element so that the light from each portion of the display element becomes any polarized light of a plurality of polarized light beams having different polarization directions; and
an optical path portion through which the light polarization-modulated by the modulation unit passes, wherein
the optical path portion is configured such that an optical path length of the light passing through the optical path portion varies depending on a polarization direction when the light is incident on the optical path portion.
(2) The optical system according to (1), wherein
the modulation unit includes a plurality of liquid crystal units in each of which a liquid crystal molecule is disposed, the plurality of liquid crystal units being individually driven,
light from a corresponding portion of each portion of the display element is incident on each of the plurality of liquid crystal units, and
the driving of each of the liquid crystal units includes changing a state of the liquid crystal molecule disposed in each of the liquid crystal units.
(3) The optical system according to (2), wherein
the state of the liquid crystal molecule includes an orientation of the liquid crystal molecule.
(4) The optical system according to any one of (1) to (3), wherein
the optical path portion is configured such that a refractive index of the light passing through the optical path portion varies depending on the polarization direction of the light.
(5) The optical system according to (4), wherein
the optical path portion includes a plurality of liquid crystal molecules disposed in the same direction.
(6) The optical system according to any one of (1) to (3), wherein
the optical path portion includes:
a first wavelength plate converting linearly polarized light from the modulation unit into circularly polarized light according to a polarization direction of the linearly polarized light;
a second wavelength plate converting the circularly polarized light from the first wavelength plate into linearly polarized light according to a rotation direction of the circularly polarized light;
a half mirror disposed between the first wavelength plate and the second wavelength plate; and
a reflective polarizing plate disposed on a side opposite to the first wavelength plate with the second wavelength plate interposed therebetween, allowing predetermined linearly polarized light to pass therethrough, and reflecting other linearly polarized light.
(7) The optical system according to any one of (1) to (6), further comprising a polarizing plate, the polarizing plate being disposed between the display element and the modulation unit and allowing only predetermined polarized light out of light beams from the display element to pass therethrough.
(8) The optical system according to any one of (1) to (7), wherein
the display element includes an organic light emitting diode (OLED).
(9) The optical system according to any one of (1) to (8), further comprising a polarizing plate, the polarizing plate being disposed on a side opposite to the modulation unit with the optical path portion interposed therebetween and rectifying the light from the optical path portion into predetermined polarized light.
(10) The optical system according to any one of (1) to (9), further comprising a plurality of lenses for forming an image of light from the display element, wherein
the plurality of lenses include:
a lens provided between the modulation unit and the optical path portion; and
two lenses provided in order on a side opposite to the modulation unit with the optical path portion interposed therebetween.
(11) The optical system according to any one of (1) to (10), further comprising:
a second modulation unit individually polarization-modulating light from each portion of the display element and having passed through the optical path portion so that the light from each portion of the display element and having passed through the optical path portion becomes any polarized light of a plurality of polarized light beams having different polarization directions; and
a second optical path portion through which the light polarization-modulated by the second modulation unit passes, wherein
the second optical path portion is configured such that an optical path length of the light passing through the second optical path portion varies depending on a polarization direction when the light is incident on the second optical path portion.
(12) The optical system according to any one of (1) to (11), wherein
a wavelength plate is stacked on the modulation unit.
(13) The optical system according to any one of (1) to (12), wherein
the display element extends in an XY plane direction, and
the plurality of polarized light beams obtained by the polarization modulation of the modulation unit include X-polarized light polarized in an X-axis direction and Y-polarized light polarized in a Y-axis direction.
(14) The optical system according to any one of (1) to (13), wherein
the display element extends in an XY plane direction, and
the plurality of polarized light beams obtained by the polarization modulation of the modulation unit include polarized light polarized in a direction between an X-axis direction and a Y-axis direction.
(15) A display device comprising:
a display element; and
an optical system forming an image of light from the display element, wherein
the optical system includes:
   a modulation unit individually polarization-modulating light from each portion of the display element so that the light from each portion of the display element becomes any polarized light of a plurality of polarized light beams having different polarization directions; and
   an optical path portion through which the light polarization-modulated by the modulation unit passes, and
the optical path portion is configured such that an optical path length of the light passing through the optical path portion varies depending on a polarization direction when the light is incident on the optical path portion.
(16) The display device according to (15), further comprising a camera for eye sensing.

### REFERENCE SIGNS LIST

1 DISPLAY DEVICE
2 DISPLAY ELEMENT
3 OPTICAL SYSTEM
4 POLARIZING PLATE
5 MODULATION UNIT
51 LIQUID CRYSTAL UNIT
5a WAVELENGTH PLATE
5m LIQUID CRYSTAL MOLECULE
6 OPTICAL PATH PORTION
6m LIQUID CRYSTAL MOLECULE
7 POLARIZING PLATE
8 OPTICAL PATH PORTION
81 WAVELENGTH PLATE
81a HALF MIRROR
82 WAVELENGTH PLATE
82a REFLECTIVE POLARIZING PLATE
9 PROJECTOR
10 CAMERA
B FLAT PLATE
E EYE
L1 LENS
L2 LENS
L3 LENS
P OBJECT POINT

What is claimed is:

1. An optical system forming an image of light from a display element, the optical system comprising:
a modulation unit individually polarization-modulating light from each portion of the display element so that the light from each portion of the display element becomes any polarized light of a plurality of polarized light beams having different polarization directions; and
an optical path portion through which the light polarization-modulated by the modulation unit passes, wherein
the optical path portion is configured such that an optical path length of the light passing through the optical path portion varies depending on a polarization direction when the light is incident on the optical path portion.

2. The optical system according to claim 1, wherein
the modulation unit includes a plurality of liquid crystal units in each of which a liquid crystal molecule is disposed, the plurality of liquid crystal units being individually driven,
light from a corresponding portion of each portion of the display element is incident on each of the plurality of liquid crystal units, and
the driving of each of the liquid crystal units includes changing a state of the liquid crystal molecule disposed in each of the liquid crystal units.

3. The optical system according to claim 2, wherein
the state of the liquid crystal molecule includes an orientation of the liquid crystal molecule.

4. The optical system according to claim 1, wherein
the optical path portion is configured such that a refractive index of the light passing through the optical path portion varies depending on the polarization direction of the light.

5. The optical system according to claim 4, wherein
the optical path portion includes a plurality of liquid crystal molecules disposed in the same direction.

6. The optical system according to claim 1, wherein
the optical path portion includes:
a first wavelength plate converting linearly polarized light from the modulation unit into circularly polarized light according to a polarization direction of the linearly polarized light;
a second wavelength plate converting the circularly polarized light from the first wavelength plate into linearly polarized light according to a rotation direction of the circularly polarized light;
a half mirror disposed between the first wavelength plate and the second wavelength plate; and
a reflective polarizing plate disposed on a side opposite to the first wavelength plate with the second wavelength plate interposed therebetween, allowing predetermined linearly polarized light to pass therethrough, and reflecting other linearly polarized light.

7. The optical system according to claim 1, further comprising a polarizing plate, the polarizing plate being disposed between the display element and the modulation unit and allowing only predetermined polarized light out of light beams from the display element to pass therethrough.

8. The optical system according to claim 1, wherein
the display element includes an organic light emitting diode (OLED).

9. The optical system according to claim 1, further comprising a polarizing plate, the polarizing plate being disposed on a side opposite to the modulation unit with the optical path portion interposed therebetween and rectifying the light from the optical path portion into predetermined polarized light.

10. The optical system according to claim 1, further comprising a plurality of lenses for forming an image of light from the display element, wherein
the plurality of lenses include:
a lens provided between the modulation unit and the optical path portion; and
two lenses provided in order on a side opposite to the modulation unit with the optical path portion interposed therebetween.

11. The optical system according to claim 1, further comprising:
a second modulation unit individually polarization-modulating light from each portion of the display element and having passed through the optical path portion so that the light from each portion of the display element and having passed through the optical path portion becomes any polarized light of a plurality of polarized light beams having different polarization directions; and
a second optical path portion through which the light polarization-modulated by the second modulation unit passes, wherein
the second optical path portion is configured such that an optical path length of the light passing through the second optical path portion varies depending on a polarization direction when the light is incident on the second optical path portion.

12. The optical system according to claim 1, wherein
a wavelength plate is stacked on the modulation unit.

13. The optical system according to claim 1, wherein
the display element extends in an XY plane direction, and
the plurality of polarized light beams obtained by the polarization modulation of the modulation unit include X-polarized light polarized in an X-axis direction and Y-polarized light polarized in a Y-axis direction.

14. The optical system according to claim 1, wherein
the display element extends in an XY plane direction, and
the plurality of polarized light beams obtained by the polarization modulation of the modulation unit include polarized light polarized in a direction between an X-axis direction and a Y-axis direction.

15. A display device, comprising:
a display element; and
an optical system forming an image of light from the display element, wherein
the optical system includes:
a modulation unit individually polarization-modulating light from each portion of the display element so that the light from each portion of the display element becomes any polarized light of a plurality of polarized light beams having different polarization directions; and
an optical path portion through which the light polarization-modulated by the modulation unit passes, and
the optical path portion is configured such that an optical path length of the light passing through the optical path portion varies depending on a polarization direction when the light is incident on the optical path portion.

16. The display device according to claim 15, further comprising a camera for eye sensing.
